(19) United States
(12) Patent Application Publication
(10) Pub. No.: US 2016/0358277 A1
(43) Pub. Date: Dec. 8, 2016

(54) SYSTEM AND METHOD FOR EVALUATING CLINICAL INFORMATION AND ROUTING MEMBERS TO CLINICAL INTERVENTIONS

(71) Applicants: Brian Neal Donhoff, Louisville, KY (US); Patrick J. Murta, Louisville, KY (US); Kiran K. Raja, Louisville, KY (US); Lowell Thomas Stevens, III, Goshen, KY (US)

(72) Inventors: Brian Neal Donhoff, Louisville, KY (US); Patrick J. Murta, Louisville, KY (US); Kiran K. Raja, Louisville, KY (US); Lowell Thomas Stevens, III, Goshen, KY (US)

(73) Assignee: HUMANA INC., Louisville, KY (US)

(21) Appl. No.: 12/797,226

(22) Filed: Jun. 9, 2010

(51) Int. Cl. G06Q 50/00; G08B 21/00; G06F 15/16

(52) U.S. Cl. CPC G06Q 50/22

(57) ABSTRACT

Disclosed embodiments describe a system and method for identifying, evaluating and routing members of a healthcare benefits system to clinical interventions. The system includes various databases that comprise member claims data and provides the infrastructure to support the integration and exchange of data among representatives of a health benefits plan. It allows for more efficient use of information via the creation and evaluation of a clinical profile that is then used to identify the clinical interventions that may be appropriate for a member. The clinical data is matched to referral thresholds and other eligibility criteria for various clinical and disease management programs to identify appropriate interventions. Member progress in the interventions is tracked to determine whether additional interventions or actions may be needed to further engage the member in health-related activities. Members that do not respond to alerts for interventions may receive further alerts.

### CROSS-REFERENCE TO RELATED APPLICATIONS

None.

### TECHNICAL FIELD

The present invention is in the field of medical data collection, manipulation, and analysis systems and methods. In particular, the present invention is directed to systems and methods for collecting and analyzing medical data related to clinical interventions and routing information based on the analysis.

### BACKGROUND OF THE ART

Escalation of medical costs has led to attempts in the past to streamline systems for providing clinical, medical and other related health interventions. Attempts to control such costs have heretofore been thwarted by cumbersome and often redundant methods of gathering, evaluating and routing information relevant to the medical care of interest. Certainly, rudimentary systems for tracking patient information have been developed, and patient treatment information has often been tracked and stored for further analysis.

In the area of disease diagnosis and detection, clinical tests and evaluations are used to obtain data regarding a patient. The clinical tests and evaluations yield a large volume of data, including patient symptoms and test results, as well as patient characteristics, such as age, weight, height, gender, and geographic location. The data can vary depending on the progression of a particular disease and when the clinical tests are conducted on a patient. The amount of clinical test data available is growing larger as additional tests are performed on an increasing number of patients. As the volume of clinical test data and the high dimensionality of such data lead to a large quantity of possible diagnoses that can result from the data. A single patient can have multiple diagnoses that could result from the same data set.

Additionally, after clinical data has been recorded and evaluated, communicating with patients regarding interventions and treatments has proved problematic. Several options may be available, often of varying degrees regarding a particular patient's needs, but typically dependent on the category of initial diagnosis. As a result, the patient may only be informed of one intervention pathway. Alternatively, a patient may be informed of several options for intervention pathways, but often by redundant or duplicative communication systems from various intervention organizations.

Therefore, there is a need for a system and method that continuously tracks patient information and patient treatment information, such as clinical pathways and interventions for the patient, incorporating these into a useful profile, and reacting in a coordinated fashion according to the recorded information. Accordingly, consistent with the goal of providing cost-effective medical care, there remains a need for integrated systems capable of tracking and analyzing medical intervention and treatment information, and leveraging the information in a manner that provides quick response to changing data. In view of the foregoing, it should be apparent that there is a need for a method of mining and analyzing clinical data to develop a patient's clinical profile, to determine appropriate disease diagnoses, and to recommend appropriate interventions and treatments. The embodiments disclosed in the present application address this issue.

### SUMMARY OF THE INVENTION

The present invention is directed to data collection, storage, analysis and manipulation systems and methods whereby medical and clinical data is collected for patients and stored in appropriate databases. A particularly effective aspect of the invention is that the system and method include functionality for continuously reviewing and updating a member's clinical profile and treatment data for trends and, where appropriate, identifying intervention candidates and routing information via various systems to inform members of a health benefits plan of the benefits and availability of interventions related to the respective clinical profile.

In addition, the system and method further comprise functionality for providing follow-up data tracking and analysis. Previous data collection systems are hindered in that, unless there is a complication, data concerning a patient's follow-up status is rarely tracked, and even when tracked, is not tracked in sufficient detail to provide meaningful information. The follow-up data tracking portion of the disclosed embodiments, however, provides a mechanism for contacting patients and generating additional, clinical intervention related data elements, wherein those elements are incorporated into the analysis of the effectiveness of particular clinical pathways.

In one embodiment the system and method creates a clinical profile for each member. A member is an individual and optionally, is enrolled in a health benefit plan. The clinical profile may generally provide information regarding several layers of data. The first and broadest layer of the clinical profile is the intervention database. The intervention database includes information regarding all of the clinical, medical and other related health interventions that are supported by a customer that sponsors the health benefits plan. This information may include diagnostic as well as treatment interventions. The second layer includes information on the specific customer and what interventions are supported by the customer profile. A customer may be an employer, a group, a company, or other entity (insurer or payer), and is generally the entity responsible for making decisions regarding what interventions are supported in the customer profile. Third, the clinical profile provides information regarding interventions available through various health service providers. Lastly, each member has a layer of data related to diagnostic results, intervention suggestions and results of past interventions. This layer is the member profile. These four layers constitute a clinical profile for each member. The information gathered and sorted in the clinical profile supports a clinical guidance process.

The clinical guidance process mines clinical profiles to classify individual members into categories. Once the system identifies applicable categories, a selection of interventions is identified based on the data in the clinical profile. The clinical guidance process then determines the most appropriate interventions for the member. A routing system and method informs the members of the interventions and routes the members to the applicable health service provider(s). The clinical profile may then be updated with information regarding outcomes from the respective interventions, and if need be additional interventions may be identified and actions taken to route the member to the interventions. Generation and updating of the clinical profile and the clinical guidance process may occur repetitively as new data is acquired or iteratively on a predetermined schedule.

### BRIEF DESCRIPTION OF THE DRAWINGS

A better understanding of the exemplary embodiments of the invention is provided in connection with the accompanying drawings, wherein identical parts are identified with identical reference numerals, and wherein:

FIG. 1 is a first schematic diagram for an example embodiment of an information evaluation and routing system according to the present invention.

FIG. 2 is a second schematic diagram for an example embodiment of an information evaluation and routing system according to the present invention.

FIG. 3 is a schematic diagram illustrating the application of clinical rules and business rules for an example embodiment of an information evaluation and routing system according to the present invention.

### DETAILED DESCRIPTION

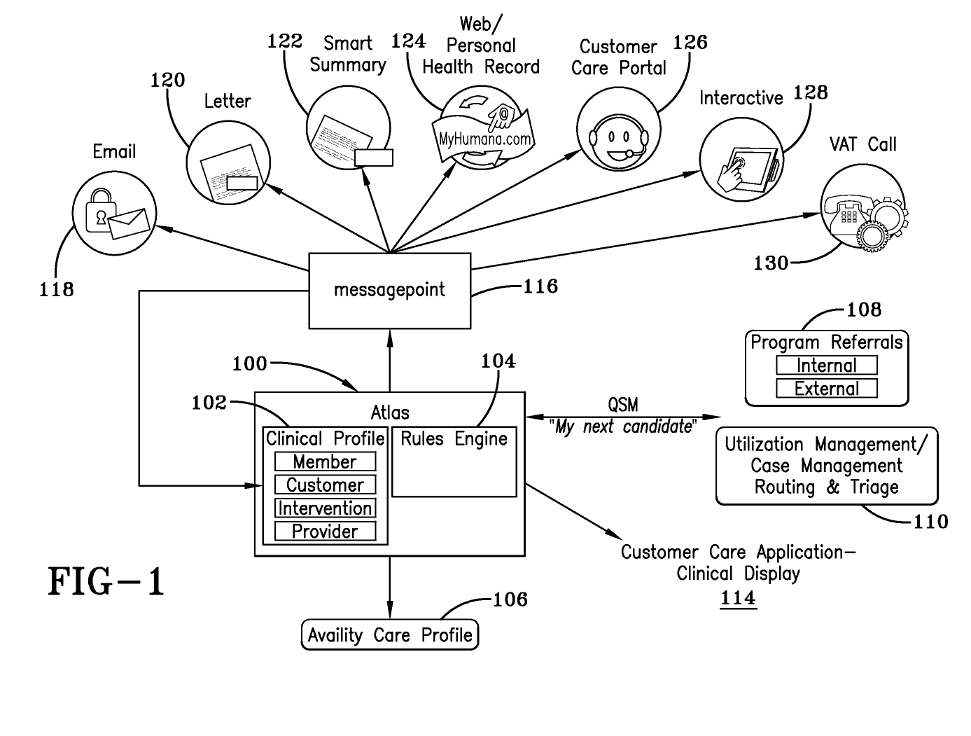

Referring to FIG. 1, a general schematic of a computerized system for identifying, evaluating and routing members and information for various clinical interventions is shown. In an example embodiment, the computerized system is operated by a health benefits plan provider that provides plans to employers, groups, and other organizations and entities or to individuals.

The method for identifying and routing members to appropriate interventions generally involves four steps. Initially, a member profile is created and stored in a clinical profile database 102. Member information from various sources is collected and stored to create a clinical profile for each member. The creation of a clinical profile is not a static undertaking. Instead, individual clinical profiles are updated as clinical data from various sources is obtained. The clinical profiles are then mined and potential candidates for various programs are identified by specific data in their clinical profiles. The pool of potential candidates is then evaluated based on predetermined rules maintained in a rules engine 104 to determine which intervention(s) or program(s) is most appropriate. Intervention data is stored in the clinical profile database 102. It is important to note that the system has the capability to reprioritize or reorder interventions based on additional data regarding the specific intervention that may make the intervention more or less desirable for a particular member/class. Once an appropriate intervention is identified the member is routed to the appropriate intervention. Moreover, several interventions may be identified by the system for a particular member, if this is the case, then the system may route the member to several interventions simultaneously, or alternatively, may route the member to individual interventions in a predetermined order.

The member profile portion of the clinical profile database 102 includes data about individual members. In an example embodiment, data that comprises the member profile includes data on clinical conditions of the member. The clinical conditions may include information provided by the member directly, such as height, weight or other demographic information. The member profile may also include data from health service providers such as, medical staff, pharmacy staff, laboratory data, referrals from these and the like. The member profile may also include information related to so-called predictive model scores. Predictive model scores are generated from data in the member profile and evaluated based on predetermined statistics regarding clinical data and certain medical or other diagnoses. The member profile may also include information regarding previous interventions. The previous intervention data may include information regarding previous interventions that the member has been referred to as well as outcomes of any previous interventions.

The member profile also includes information on communications routed to the individual member as well as preferred methods and data for contacting the member. This data may be used to determine the best method for routing information to the member regarding interventions and additionally may be used in conjunction with data from other clinical profiles to prioritize means for communicating with members based on successful communications. Means for communication that prove to be more successful with segments of the member pool may be more effectively utilized. Generation and updating of the member profile and the communication process may occur repetitively as new data is acquired or iteratively on a predetermined schedule. In an example embodiment, the member profile may be maintained using the Availity® Care Profile 106 product from Availity, LLC. The Availity care profile is an electronic health record sourced by claims-based information that provides a consolidated view of patients' health care services across physicians and providers.

The clinical profile database 102 also includes a customer profile. An example of a customer is an employer group. The defining characteristic of a customer is the shared set of interventions provided for in the particular benefits plan for the customer's members. Each customer profile includes information regarding the interventions selected for the members. This data may include information on the cost to the customer for the individual interventions. Additionally, the customer profile includes information on clinical activities and interventions that occur outside of the predetermined intervention set, but are nonetheless accommodated by the insurer in some form. This data includes information from outside providers that are not supported but are related to services supported by the insurer and the customer's profile.

The clinical profile database 102 includes an intervention profile as well. Generally, an intervention profile includes information about specific treatment and maintenance programs for various health conditions. The intervention profile includes information about the programs such as: the entity that provides and/or administers the intervention; costs associated with the intervention (whether born by the member, the customer or the insurer); and exclusion and/or referral thresholds among other information. Data specific to various health conditions (e.g., clinical diagnoses, blood pressure, test results, etc.) may be used to establish the referral thresholds.

The clinical profile includes a provider profile. A provider includes organizations or institutions such as hospitals and related healthcare facilities, but also incorporates individual providers of medical-related services and interventions such as doctors, pharmacists, therapists, nurses and the like. On a more general level, a provider is an entity that requests payment for intervention costs either from the insurer or the member. The provider profile includes data on interventions provided by the provider. The provider profile may include information on costs associated with each intervention provided by individual providers. The provider profile may include data on success rates for individual providers for specific interventions. The provider profile includes information on exclusion and/or referral thresholds related to individual providers.

An important aspect of the disclosed embodiments is the integration of intervention data in one centralized system. This structure allows an insurer to leverage a wider breadth of data for individual members in determining which intervention is most appropriate. Additionally, this arrangement allows for significant cost savings as redundant communication systems are not necessary as a central routing system may be used to communicate with members rather than individual systems devoted to intervention categories (i.e., medical, dental, physical therapy and pharmacological). At the center of the system is a data analysis and transaction component 100 comprising the clinical profile database 102 and a rules engine 104. The rules engine 104 comprises clinical as well as business rules and logic for analyzing the member clinical profile data and determining appropriate interventions for managing all aspects of a member's care. The rules engine logic creates transactions involving alerts, notices, tasks, etc. based on the data analysis.

Some transactions comprise communications with members through a messaging component 116. Information in a member's profile may indicate preferred communication channels or methods for receiving communications (e.g., email 118, letters 120, smart summary 122 consumer-focused health benefits budgeting, planning, and reporting document, web/personal health record 124). The messaging component 116 may also comprise various communication channels that allow the members to contact the health benefits plan provider (e.g., web/personal health record portal 124, interactive tools 128, and voice activated technology 130). A member's interactions with the communication channels as well as response to health benefits plan provider communications are recorded in a contact history and analyzed for future transactions to determine the most effective communications channels as well as whether the member is responding to communications and taking advantage of the services and products that are offered.

Each member's profile data and contact history is accessible to health benefit plan provider customer care representatives through a customer care portal 126. A customer care application 114 facilitates the display of member contact history data to clinical customer care representatives. The contact history provides details of contacts between the member and the health benefits plan provider. Contacts may relate to a variety of events such as a written communication from the provider to the member inviting the member to participate in a disease management program, a call from the member to a customer care representative requesting information about a disease management program, a member connection to the health plan provider web site, etc. The date and outcome of each contact may be recorded to evaluate the effectiveness of the contacts. Outcomes relate to member's response to various requests and invitations made by the health plan provider. For example, a member's response or non-response to an invitation to join a disease management program may be recorded as an outcome.

The ability of customer care representatives to view a member's profile data and contact history allows the customer care representatives to identify additional opportunities to reach out to the member and provide appropriate information and/or direct him or her to appropriate interventions or programs. The customer care representative may see that the member has not responded to a prior contact and may, through a conversation with the member, discuss the substance of the communication with the member and address any concerns that the member has. The clinical customer care representative may further see through the customer care application 114 member information regarding referral eligibility, disease management, and a severity score history for a particular condition and further use this information to communicate program information to a member.

Specific communications from the health benefits plan provider may be directed to more than one communication channel to increase the likelihood that the member receives and responds to the contact. For example, the rules engine may identify members that qualify for alerts related to Healthcare Effectiveness Data and Information Set (HEDIS®) reviews. HEDIS measures relate to specific measures that are designed to assess various health conditions. As new measures are defined or old measures are updated, members may be notified of the changes and asked whether they are interested in updating their profile data with new measurements. The alerts or notifications may be provided through customer care application 114 to a clinical customer care representative that provides information about the measures when talking with a member or through a customer care portal 126 accessible to the member.

A customer care application 114 for communicating with nurses and clinical specialists receives information about member candidates for utilization management/case management routing and triage 110 as well as program referrals 108. The utilization management/case management routing and triage data 110 comprises clinical guidance and disease management data that is used to identify the interventions that are appropriate for a particular member based on the member's profile data. The program referral data 108 provides information about specific programs that may be available to the member. Members may be matched with programs based on an analysis of the data from clinical profile database 102. When members contact the health benefits plan provider, a clinical customer care representative may be alerted to the member's eligibility for a program or need for a particular intervention. The customer care representative may take advantage of the opportunity to discuss the member's needs and direct him or her to the program. Data regarding the contact and outcome of the discussion is recorded in the member's clinical profile and considered in future communications with the member.

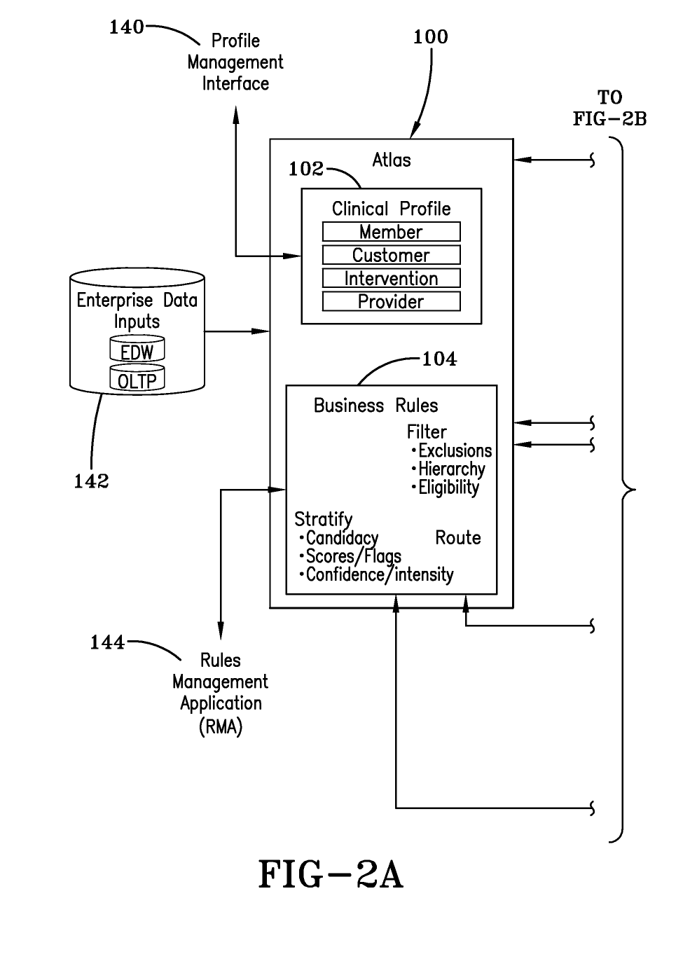

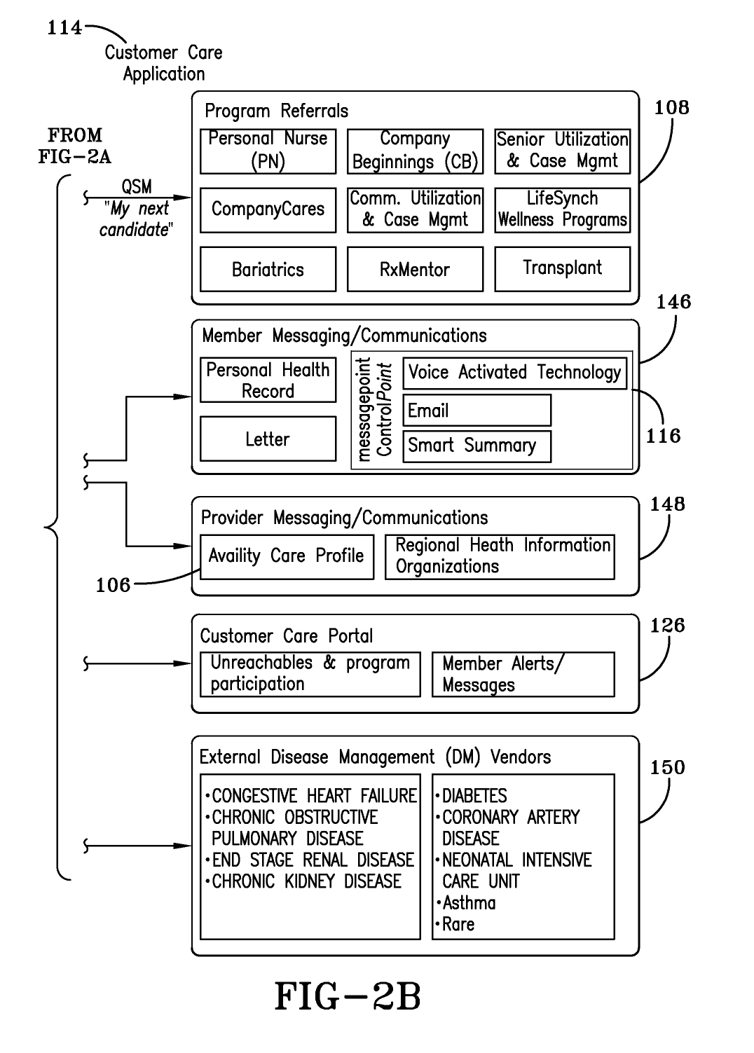

Details regarding the program referrals of the customer care application 114 are illustrated in FIG. 2. In an example embodiment, program referrals 108 include:

TABLE 1
Program Referrals

| Program | Description |
|---|---|
| Personal Nurse (PN) | Phone-based service for members; specially- |
| | trained nurses provide health education |
| | and counseling |
| Company Beginnings | Program for expectant mothers |
| (CB) | |
| Senior Utilization and | Service for senior members; case managers |
| Case Management | work with members to assess needs and |
| | develop goals |
| Company Cares | Chronic care management program; service |
| | to coordinate care from multiple providers |
| Communication | Service for all members; case managers |
| Utilization and | work with members to facilitate and |
| Case Management | increase communication |
| Wellness Programs | Programs to encourage members to take |
| | an active role in health care |
| Bariatrics | Service to assist members though evaluation, |
| | inpatient stay, and post-operative period |
| Prescription Mentor | Phone-based service for members; pharmacists |
| | provide medication safety education and |
| | counseling |
| Transplant | Service to assist members though evaluation, |
| | inpatient stay, and post-operative period |

FIG. 2 is a schematic illustrating the flow of information through the computerized system. Data inputs 142 to the data analysis and transaction component 100 include data from an enterprise data warehouse (EDW) and online transaction processing (OLTP) applications. A profile management interface application 140 facilitates management of the clinical profile data 102 including the addition or deletion of data fields used to store profile data. A rules management application 144 facilitates management of the business and clinical rules 104. Categories of rules include rules to stratify members (e.g., according to candidacy, scores/flags, confidence/intensity), to filter members (e.g., by applying exclusionary rules, according to a hierarchy, or by eligibility rules), and to route transactions to candidate pools of members.

The business and clinical rules component 104 comprises an identification engine that operates on a set of intake rules, categorizing members based on input data. Once member information has passed through the identification engine, it is subject to further processing. First, the member information is subjected to a set of evaluation rules for determining what interventions match the member information. The evaluation rules may consider health conditions data and other factors when processing member data. Second, the member information is subjected to a set of routing rules for determining the appropriate route for directing the member. The routing rules may include rules for scheduling appointments, communicating with the member, and the like. The member profile is updated based on the member's responses to the various communications. Additionally, there is feedback from the various interventions to the identification engine. This feedback allows for re-evaluation of identification and intake rules based on outcomes of the interventions.

Transactions are defined and processed using additional functional components that interact with the data analysis and transaction component 100. A member messaging and communications component 146 facilitates member communications. Each member may periodically receive a personal health record that provides various personal health measures and information about health conditions. Additional information regarding the member's health and related benefits may be communicated in letters. A message point component 116 supports other communication channels such as voice activated technology, email messages, and a smart summary statement that provides health benefits budgeting, planning, and reporting information.

A provider messaging component 148 facilitates communications with health providers. The Availity care profile 106 provides each health provider with a consolidated view of patients' health care services across physicians and providers. The profile assists the provider in understanding the member's current state of health and what services have been provided previously. The information assists the provider in determining further actions that may be appropriate for the member. Communications with regional health information organizations assist the organizations in providing services that may be applicable to a large portion of the member population within the region.

A customer care portal 126 provides clinical customer care representatives with comprehensive information regarding a member's health as well as prior attempts to communicate with the member. The tracking of member outcomes or responses in connection with a variety of communications allows the health benefits plan provider to determine which methods of communication are most effective. In addition, it allows a clinical customer care representative to initiate a dialog with individual members to better understand why they may not have responded to prior communications. Finally, the clinical customer care representative is alerted to programs and interventions that are appropriate for the member. The clinical customer care representative can then alert the member to the opportunities.

A vendor disease management component 150 provides details about various programs in which members may be enrolled. Each member's clinical profile data may be used to identify the program or programs that are appropriate for the member. Participation in more than one program may be appropriate for members that have symptoms related to different health conditions. Eligibility to participate in programs depends upon the customer profile and whether the customer offers its member benefits in the form of disease management programs. Information regarding the member's health and eligibility may be communicated to a clinical customer care representative so that the representative can encourage members who have previously been unresponsive to participate in appropriate programs.

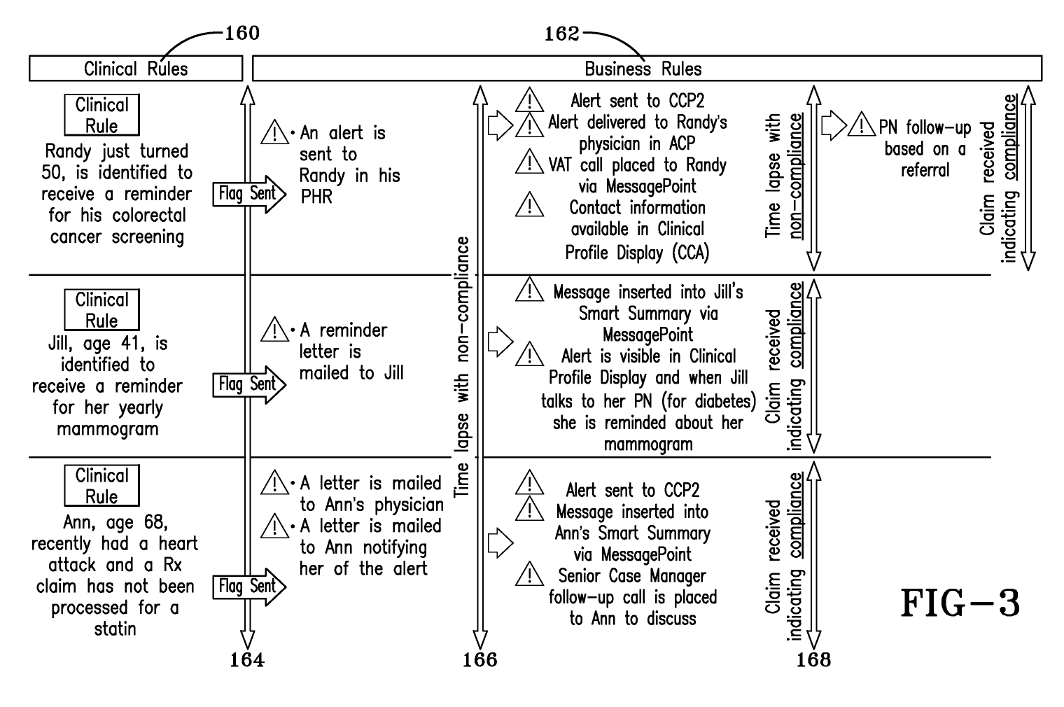

Referring to FIG. 3, a schematic diagram illustrating the application of clinical rules and business rules according to an example embodiment is shown. The clinical rules 160 are applied to the clinical profile data to classify or categorize members for various interventions. Each intervention may have clinical referral thresholds such as a specified age, a specified age and sex, a particular diagnosis, certain test results, etc. For example, female members over the age of 40 may be classified into a group of members requiring a yearly mammogram. Initially, a business rule 162 for mailing a mammogram reminder letter to members in the class may be triggered 164. The business rules may have an associated compliance period 166 for completing a task identified in a communication forwarded to the member. The member contact history is updated to record the date when the mailing is sent and to start monitoring the member's compliance. If the member fails to complete the task and respond to the notice or communication within the compliance period 166, additional actions associated with the business rule 162 may be triggered. For example, additional alerts and/or notices may be transmitted to the member's physician. Each business rule may involve one or more actions such as sending communications to the member and/or the member's physician. Various techniques for monitoring compliance may used in addition to recording the date a communication was sent. For example, compliance may be monitored by identifying in the member profile a date by which a member action should be completed or a number of days during which a notice of compliance should be received.

Alerts may also be entered in a member's clinical profile to assist customer care representatives involved in assisting members with various health questions and conditions, enrolling members in clinical disease management, etc. The alerts in the clinical profile assist representatives in their interactions with members by providing specific information regarding a member's condition or circumstances. The representative sees the alert when accessing the clinical profile and may complete additional tasks such as calling the member to assist the member with the condition. If the member initiates a contact with a customer care representative, the representative may be prompted to access the clinical profile, see the alert, and then discuss the condition and clinical intervention with the member while the member is on the telephone.

Information related to an alert may be forwarded to members through a variety of communication channels including telephone calls (using Voice Activated Technology), email messages, messages in personal health records and health benefits summary statements, login messages appearing at a web site, etc. Once an alert is issued, the member's contact history is updated to indicate the communication was sent and to start monitoring for compliance with the alert within a specified period of time 168. Member claim data may be reviewed to confirm compliance with an alert (e.g., a follow-up visit with a physician, enrollment in a disease management program, etc.). If a member fails to respond to a first alert, a second alert may be issued (e.g., a follow-up telephone call). Compliance with the second alert is also monitored by reviewing claim data. If a member fails to respond to a second alert, additional alerts may be issued and actions taken to encourage compliance with the alert. Outcomes of each of the member contacts are recorded and may be used to determine the most effective means of communicating with a member.

The member clinical profile data may be accessible to a variety of portals and/or software applications used by customer care representatives, case managers, personal nurses, and other personnel involved in providing services to members as well as through automated applications that provide messages and communications to members. Other software applications may access member clinical profile data to include alerts in written, electronic, or telephone communications. Each portal and/or software application may be designed to receive and respond to alerts from the business rules and to generate or support further communications with members. A list of example portals and applications (which appear in FIG. 3) are identified in Table 2.

TABLE 2
Portals and Applications Accessing Member Clinical Profiles

| Portal/Application | Description |
|---|---|
| Clinical Care | Online system for managing and organizing member |
| Advance (CCA) | clinical data |
| Customer Care | Online system for managing and organizing member |
| Portal (CCP) | healthcare information and tracking compliance |
| Personal Nurse | Phone-based service for members; specially-trained |
| (PN) | nurses provide health education and counseling |
| Personal Health | Written or electronic communication directed to |
| Record (PHR) | member with personal health information |
| Voice Activated | Telephonic communication directed to member |
| Technology (VAT) | |
| Pharmacy (Rx) | Medicine safety communication directed to member |

The combination of clinical rules and business rules represent numerous potential opportunities for member as well as provider engagement. Alerts may be directed to a customer care portal or clinical care advance application and to individual caregivers. Alerts may be directed to a clinical program referral system so that personnel involved in enrolling and engaging members in programs know to contact the identified members. Messages and communications related to alerts may be delivered to members using various communication channels such as postal mail, email, voice activated technology calls or in health records or benefit summaries. Alerts may also be forwarded to a member's clinical profile so that any individual or application accessing the profile sees the alert and can respond to it appropriately. Alerts and messages may also be forwarded to providers that are involved in a member's healthcare. In response to receiving an alert or message, the provider may contact the member to schedule an appointment, issue a prescription, etc.

Having shown and described an embodiment of the invention, those skilled in the art will realize that many variations and modifications may be made to affect the described invention and still be within the scope of the claimed invention. The clinical and business rules may be implemented in a variety of ways and fall within the scope of the claimed invention. Details of the clinical profile, alerts, and resulting actions and messages may be varied and fall within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

1-7. (canceled)

8. A computerized method for advising a member of a health benefits plan of a clinical intervention relevant to said member's health condition comprising:
(a) storing in a computerized database member profile data for members of said health benefits plan, said member profile data comprising:
(i) health condition data;
(ii) at least one preferred communication channel for receiving communications regarding a clinical intervention; and
(iii) contact history data;
(b) storing in said computerized database clinical intervention data for a plurality of clinical interventions, said clinical intervention data comprising referral thresholds for each clinical intervention;
(c) storing in said computerized database customer profile intervention data:
(i) comprising member eligibility data; and
(ii) identifying which of said plurality of clinical interventions are supported by said health benefits plan;
(d) executing at a server a process comprising instructions to access said member profile data and said clinical intervention data to:
(i) match member health condition data with clinical intervention referral thresholds for at least one clinical intervention to identify a plurality of members with health conditions matching said clinical intervention referral thresholds;
(ii) confirm using customer profile intervention data that:
(1) said clinical intervention is supported by said health benefits plan; and
(2) said plurality of members are eligible to participate in said clinical intervention;
(iii) automatically generate and store in a member profile for each said plurality of members:
(a) a member action for said clinical intervention; and
(b) a compliance period of time for completing said member action;
(iv) automatically record in said contact history for each of said plurality of members an outcome to a communication regarding said member action for said clinical intervention;
(e) receiving from a client computer at said server a request to access a member profile for one of said plurality of members;
(f) accessing at said server from said computerized database said member profile, said member profile comprising said contact history;
(g) transmitting from said server to said client computer for display said contact history of member profile and said outcome to said communication regarding said member action for said clinical intervention; and
(h) transmitting from said server to said client computer for display a second communication for said clinical intervention if said contact history of said member profile does not indicate said member responded to said first communication for said clinical intervention during said compliance period.

9. The computerized method of claim 8 wherein said client computer is a user computer for said one of said plurality of members.

10. The computerized method of claim 8 wherein said client computer is a user computer for a representative of said health benefits plan.

11. The computerized method of claim 8 wherein receiving from a client computer a request to access a member profile comprises receiving said request in connection with a telephone call from said one of said plurality of members to said representative.

12. The computerized method of claim 8 wherein said member action is enrolling said member in said clinical intervention.

13-14. (canceled)

15. A system for advising a member of a health benefits plan of a clinical intervention relevant to said member's health condition comprising:
(a) a server comprising at least one computerized database with:
(1) member profile data for members of said health benefits plan, said member profile data comprising:
(i) health condition data; and
(ii) contact history data;
(2) clinical intervention data for a plurality of clinical interventions, said clinical intervention data comprising referral thresholds for each clinical intervention;
(3) customer profile intervention data:
(i) comprising member eligibility data; and
(ii) identifying which of said plurality of clinical interventions are supported by said health benefits plan;
(b) a process executing at said server configured to perform the steps of:
(1) matching member health condition data with clinical intervention referral thresholds for at least one clinical intervention to identify a plurality of members with health conditions matching said clinical intervention referral thresholds;
(2) confirming using customer profile intervention data that:
(i) said clinical intervention is supported by said health benefits plan; and
(ii) said plurality of members are eligible to participate in said clinical intervention;
(3) generating and storing in a member profile for each of said plurality of members:
(i) a member action for a clinical intervention; and
(ii) a compliance period of time for completing said member action;
(4) generating a first communication of a first communication type for each of said plurality of members regarding said member action for clinical intervention;
(5) recording in a contact history of at least one of said plurality of members that fails to complete said member action during said compliance period a non-response outcome;
(6) generating a second communication regarding said member action for said clinical intervention of a second communication type for said at least one of said plurality of members regarding said member action;
(7) delivering said first communication to said plurality of members according to a preferred communication channel for each of said plurality of members; and
(8) transmitting from said server to said client computer for display said second communication for said clinical intervention if said contact history of said member profile does not indicate said member responded to said first communication for said clinical intervention during said compliance period.

16. (canceled)

17. The system of claim 15 wherein said preferred communication channel is selected from the group consisting of an email message, a postal letter, a health benefits summary statement, and a personal health record.

18. The system of claim 15 wherein said member action is enrolling said member in said clinical intervention.

19. The system of claim 15 wherein said first communication for said clinical intervention is displayed on a health benefits plan representative's client computer in response to a request to access a member profile in connection with a telephone call from said one of said plurality of members.

20. (canceled)
